(19) United States
(12) Patent Application Publication
(10) Pub. No.: US 2025/0046853 A1
(43) Pub. Date: Feb. 6, 2025

(54) JELLY ROLL AND BATTERY

(71) Applicant: ZHUHAI COSMX BATTERY CO., LTD., Zhuhai (CN)

(72) Inventors: Yixin YAO, Zhuhai (CN); Wenxuan ZHANG, Zhuhai (CN); Honglei ZHANG, Zhuhai (CN); Junyi LI, Zhuhai (CN)

(73) Assignee: ZHUHAI COSMX BATTERY CO., LTD., Zhuhai (CN)

(21) Appl. No.: 18/924,969

(22) Filed: Oct. 23, 2024

Related U.S. Application Data
(63) Continuation of application No. PCT/CN2023/098034, filed on Jun. 2, 2023.

(30) Foreign Application Priority Data
Aug. 23, 2022 (CN) 202222216587.2

(51) Int. Cl. H01M 10/04; H01M 50/463; H01M 50/474

(52) U.S. Cl. CPC H01M 10/0431; H01M 50/463; H01M 50/474

(57) ABSTRACT

A jelly roll includes a first electrode plate and a second electrode plate that are disposed in a stacked manner. The tail end of the first electrode plate is a first foil uncoating region; the tail end of the second electrode plate is a second foil uncoating region; and the jelly roll includes a first bending region disposed at an outermost side of the jelly roll, the tail end of the first electrode plate and the tail end of the second electrode plate are both located in the first bending region, and neither of projections, in a thickness direction of the jelly roll, of the first foil uncoating region and the second foil uncoating region exceeds the first bending region. The present disclosure solves problems of being unable to ensure both safety and an energy density of a battery.

### CROSS-REFERENCE TO RELATED APPLICATIONS

This application is a continuation of International Application No. PCT/CN2023/098034, filed on Jun. 2, 2023, which claims priority to Chinese Patent Application No. 202222216587.2, filed on Aug. 23, 2022. The disclosures of the aforementioned applications are hereby incorporated by reference in their entireties.

### TECHNICAL FIELD

The present disclosure relates to the field of battery technologies, and in particular, to a jelly roll and a battery.

### BACKGROUND

Since a battery is commercialized, the battery has been widely used in the fields of portable electronic products, new energy vehicles and the like due to its excellent electrochemical performance, low self-discharge, ability to be rapidly charged and discharged, high energy density and the like.

A battery is composed of a positive electrode plate, a negative electrode plate, a separator, an electrolyte, etc. Due to organic and flammable nature of the electrolyte and poor thermal stability of a positive electrode material, when a nail penetration test is performed, a short circuit occurs instantaneously between the positive and negative electrodes of the battery, thereby leading to a large amount of Joule heat. When heat accumulates to a certain degree, a chemical reaction is triggered, thereby leading to chemical heat, and accumulation of the heat may lead to thermal runaway, and in severe cases, the accumulation of the heat may cause a battery to fire or even explode.

### SUMMARY

The present disclosure aims to solve problems of safety of existing batteries.

For solving the above problems, a first aspect in the present disclosure provides a jelly roll, including: a first electrode plate and a second electrode plate that are disposed in a stacked manner. The first electrode plate is wound from a start end of the first electrode plate to a tail end of the first electrode plate, and the second electrode plate is wound from a start end of the second electrode plate to a tail end of the second electrode plate. The tail end of the first electrode plate is a first foil uncoating region, and the tail end of the second electrode plate is a second foil uncoating region. The jelly roll includes a first bending region disposed at an outermost side of the jelly roll, the tail end of the first electrode plate and the tail end of the second electrode plate are both located in the first bending region, and neither of projections, in a thickness direction of the jelly roll, of the first foil uncoating region and the second foil uncoating region exceeds the first bending region.

Further, a size, along a winding direction, of the first foil uncoating region ranges from 0.1 mm to πT/2+8 mm, where T is a thickness of the jelly roll.

Further, a size, along a winding direction, of the second foil uncoating region ranges from 0.1 mm to 10 mm.

Further, the first electrode plate includes a first current collector and a first active material layer, and at a position where the first foil uncoating region is located, neither of two side surfaces of the first current collector is coated with the first active material layer.

Further, the first electrode plate further includes a priming coat located between the first current collector and the first active material layer.

Further, the first electrode plate, disposed at an outermost ring of the jelly roll, is further provided with an insulating protective layer, the insulating protective layer is disposed on a side surface, away from the first active material layer, of the first current collector, and the insulating protective layer extends to a tail end of the first foil uncoating region.

Further, the first electrode plate is sequentially provided with a third foil uncoating region, a first electrode plate double-sided coating region, a first electrode plate single-sided coating region and the first foil uncoating region along a winding direction.

Further, the second electrode plate is sequentially provided with a fourth foil uncoating region, a second electrode plate single-sided coating region, a second electrode plate double-sided coating region and the second foil uncoating region along the winding direction.

Further, in the thickness direction of the jelly roll, a projection of the second electrode plate double-sided coating region covers a projection of a junction between the first electrode plate single-sided coating region and the first foil uncoating region.

Further, the first foil uncoating region extends beyond the second foil uncoating region along the winding direction.

Further, a distance from a junction between the second electrode plate double-sided coating region and the second foil uncoating region to a first end face is greater than or equal to T/2 mm and is less than or equal to T/2+8 mm, and the first end face is a face formed by extending a most protruding point of a bending region of the jelly roll along the thickness direction of the jelly roll, where T is a thickness of the jelly roll.

Further, the jelly roll further includes a first tab and a second tab, the first tab is disposed in the third foil uncoating region, the second tab is disposed in the fourth foil uncoating region, and projections of the first tab and the second tab do not overlap in the thickness direction of the jelly roll.

Further, the jelly roll further includes an insulating layer, the insulating layer includes a first insulating layer, a second insulating layer, a third insulating layer, a fourth insulating layer, a fifth insulating layer, a sixth insulating layer, and a seventh insulating layer, the fifth insulating layer covers a surface of the first tab, the sixth insulating layer covers a surface of the second tab, the seventh insulating layer covers a position, opposite to a start end of the third foil uncoating region, of the second electrode plate, the fourth insulating layer covers a junction between the third foil uncoating region and the first electrode plate double-sided coating region, the third insulating layer covers a junction between the first electrode plate double-sided coating region and the first electrode plate single-sided coating region, the second insulating layer covers a junction between the first electrode plate single-sided coating region and the first foil uncoating region, the first insulating layer covers at least one of a side surface, facing towards an outside of the jelly roll, of the first foil uncoating region and a surface side, away from a first current collector of the first electrode plate, of an insulating protective layer, and the insulating protective layer is disposed on the first electrode plate disposed at an outermost ring of the jelly roll.

Further, the first insulating layer extends towards the first bending region, and in the thickness direction of the jelly roll, a projection of the first insulating layer covers a projection of the first bending region.

Further, polarities of the first electrode plate and the second electrode plate are opposite, the first electrode plate is a positive electrode plate, and the second electrode plate is a negative electrode plate.

Further, the second electrode plate includes a second current collector and a second active material layer, and at a position where the second foil uncoating region is located, neither of two side surfaces of the second current collector is coated with the second active material layer.

Further, the jelly roll further includes a separator disposed between the first electrode plate and the second electrode plate, and the separator is wound from a start end of the separator to a tail end of the separator.

Further, the tail end of the separator exceeds beyond a tail end of the second foil uncoating region.

Further, the separator is provided with two tail ends, the two tail ends wrap a tail end of the second foil uncoating region.

A second aspect of the present disclosure provides a battery, including a housing and the jelly roll according to the first aspect, and the jelly roll is packaged in the housing.

In the jelly roll and the battery of the present disclosure, the first foil uncoating region disposed at the tail end of the first electrode plate and the second foil uncoating region disposed at the tail end of the second electrode plate are designed to be located in the first bending region, and the projections, in the thickness direction of the jelly roll, of the first foil uncoating region and the second foil uncoating region are designed to not exceed the first bending region, so that the first foil uncoating region and the second foil uncoating region are both located in the first bending region, but both the first foil uncoating region and the second foil uncoating region are wound around part of the first bending region, which makes pass rates of nail penetration more consistent at different positions of a jelly roll, thereby avoiding problems of inconsistent pass rates of nail penetration at different positions, and thus facilitating improving safety performance of a battery. In addition, both the first foil uncoating region and the second foil uncoating region that are located at the tail end of the jelly roll are wound around part of the first bending region, which reduces a size of foil uncoating regions that do not contribute to capacity, thereby facilitating improving an energy density of a battery. Additionally, having both the two foil uncoating regions at the tail end of the jelly roll in the first bending region, as opposed to two foil uncoating regions being on a flat plane, reduces a risk of burrs, formed by cutting a tail end of a jelly roll, piercing through the separator of the jelly roll, which can effectively reduce short circuit points of a jelly roll, thereby improving consistency of self-discharge of a jelly roll.

### BRIEF DESCRIPTION OF THE DRAWINGS

FIG. 1 is a schematic structural diagram of a jelly roll according to an embodiment of the present disclosure.

FIG. 2 is a schematic structural diagram of a first electrode plate according to an embodiment of the present disclosure.

FIG. 3 is a schematic structural diagram of a second electrode plate according to an embodiment of the present disclosure.

FIG. 4 is a schematic structural diagram of nail penetration of a jelly roll according to an embodiment of the present disclosure.

FIG. 5 is a schematic structural diagram of nail penetration of a conventionally structured jelly roll in the prior art.

### DETAILED DESCRIPTION OF THE EMBODIMENTS

The technical solutions of the present disclosure are described in a clear and detailed manner below with reference to the accompanying drawings. It should be noted that in the description of the present disclosure, orientations or positional relationships, indicated by the terms “center”, “longitudinal”, “lateral”, “length”, “width”, “thickness”, “upper”, “lower”, “front”, “rear”, “left”, “right”, “upright”, “vertical”, “horizontal”, “top”, “bottom”, “inner”, “outside”, and the like, are based on the orientations or positional relationships shown in the accompanying drawings, which is merely used to facilitate describing the present disclosure and simplify the description, rather than indicating or implying that a device or an element to which they refer must have a specific orientation and be constructed and operated in a specific orientation, and therefore, cannot be understood as a limitation to the present disclosure. In addition, the terms “first” and “second” are only used for descriptive purposes and cannot be understood as indicating or implying relative importance or suggesting a number of technical features to which they refer. Therefore, features defined with “first” and “second” may explicitly or implicitly include one or more of the features. In addition, in the description of the present disclosure, the meaning of “at least one” is one or more, unless otherwise specifically defined.

In the description of the present specification, the term “on the basis of the above embodiments” means that specific features, structures, materials, or characteristics described in conjunction with that embodiment or example is included in at least one preferred embodiment or preferred example of the present disclosure. In this specification, the schematic representations of the above terms do not necessarily refer to the same implementation or instance. Furthermore, the described specific features, structures, materials, or characteristics may be combined in any one or more embodiments or examples in a suitable manner.

In the related technologies, in order to improve nail penetration performance of a battery, for example, the nail penetration performance of a lithium-ion battery. An aluminum foil uncoated with active material layer at a tail end of a positive electrode plate may be pretreated, for example, an insulating layer is coated on the aluminum foil uncoated with active material layer at the tail end of the positive electrode plate. However, when a nail pierces into a battery cell through the pretreated aluminum foil uncoated with active material layer at the tail end, contact between the aluminum foil and a negative electrode active material layer is very easily triggered, thereby causing a battery to ignite and burn. When the nail pierces into the battery cell through a position that does not contain the aluminum foil uncoated with active material layer at the tail end, a probability of the contact between the aluminum foil and the negative electrode active material layer is obviously reduced, and a pass rate of nail penetration obviously improved. Although this structure can improve nail penetration performance of a battery, there are problems of inconsistent safety at different positions of a battery cell. In addition, the aluminum foil uncoated with active material layer at the tail end of the positive electrode plate does not contain a positive electrode active material layer on either sides, and the aluminum foil uncoated with active material layer occupies a space inside the battery cell and does not contribute to capacity, which may affect an energy density of a battery, thereby failing to ensure both safety and an energy density of a battery.

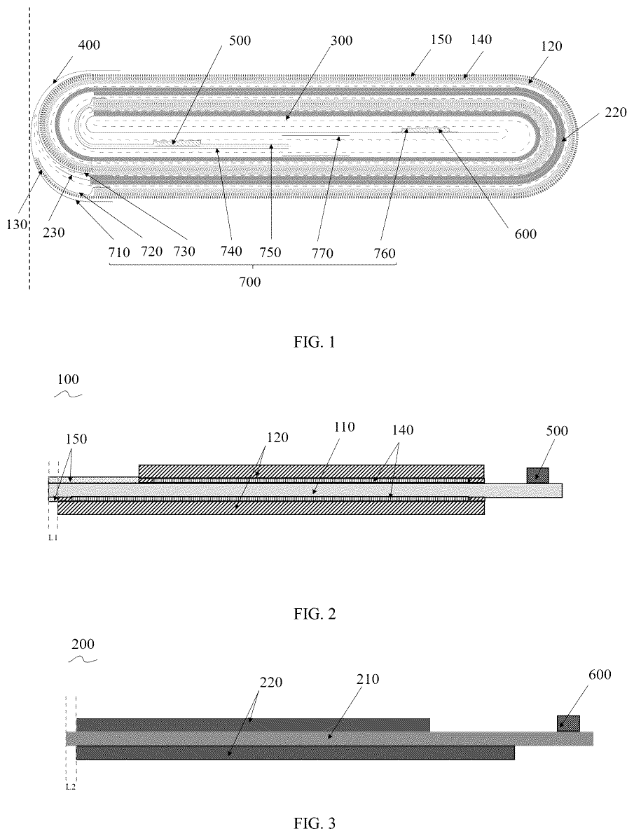

With reference to FIG. 1 to FIG. 3, the embodiments of the present disclosure provide a jelly roll, including a first electrode plate 100, a second electrode plate 200 and a separator 300 disposed between the first electrode plate 100 and the second electrode plate 200, and polarities of the first electrode plate 100 and the second electrode plate 200 are opposite.

The first electrode plate 100, the separator 300 and the second electrode plate 200 are disposed in a stacked manner, and are all wound from a start end to a tail end to form the jelly roll. The first electrode plate 100 is wound from a start end of the first electrode plate 100 to a tail end of the first electrode plate 100, the second electrode plate 200 is wound from a start end of the second electrode plate 200 to a tail end of the second electrode plate 200, and the separator 300 is wound from a start end of the separator 300 to a tail end of the separator 300.

The first electrode plate 100 includes a first current collector 110 and a first active material layer 120, and the first active material layer 120 is coated on a surface of the first current collector 110. The tail end of the first electrode plate 100 is a first foil uncoating region 130 where the first active material layer 120 is not coated on both sides of the first current collector 110.

The second electrode plate 200 includes a second current collector 210 and a second active material layer 220, and the second active material layer 220 is coated on a surface of the second current collector 210. The tail end of the second electrode plate 200 is a second foil uncoating region 230 where the second active material layer 220 is not coated on both sides of the second current collector 210.

The jelly roll includes a first bending region 400 disposed at an outermost side of the jelly roll, the tail end of the first electrode plate 100 and the tail end of the second electrode plate 200 are both located in the first bending region 400, and neither of projections, in a thickness direction of the jelly roll, of the first foil uncoating region 130 and the second foil uncoating region 230 exceeds the first bending region 400.

In the jelly roll provided in the embodiments, the first foil uncoating region 130 disposed at the tail end of the first electrode plate 100 and the second foil uncoating region 230 disposed at the tail end of the second electrode plate 200 are designed to be located in the first bending region 400, and the projections, in the thickness direction of the jelly roll, of the first foil uncoating region 130 and the second foil uncoating region 230 are designed to not exceed the first bending region 400, so that the first foil uncoating region 130 and the second foil uncoating region 230 are both located in the first bending region 400, but both the first foil uncoating region 130 and the second foil uncoating region 230 are wound around part of the first bending region 400, which makes pass rates of nail penetration more consistent at different positions of a jelly roll, thereby avoiding problems of inconsistent pass rates of nail penetration at different positions, and thus facilitating improving safety performance of a battery. In addition, both the first foil uncoating region 130 and the second foil uncoating region 230 that are located at the tail end of the jelly roll are wound around part of the first bending region 400, which reduces a size of foil uncoating regions that do not contribute to capacity, thereby facilitating improving an energy density of a battery. Additionally, having both the two foil uncoating regions 130, 230 at the tail end of the jelly roll in the first bending region 400, as opposed to two foil uncoating regions being on a flat plane, reduces a risk of burrs, formed by cutting a tail end of a jelly roll, piercing through the separator 300 of the jelly roll, which can effectively reduce short circuit points of a jelly roll, thereby improving consistency of self-discharge of a jelly roll.

The start end of the first electrode plate 100 and the start end of the second electrode plate 200 respectively refer to an end where winding of the first electrode plate 100 starts and an end where the winding of the second electrode plate 200 starts during a winding process of the jelly roll, and the tail end of the first electrode plate 100 and the tail end of the second electrode plate 200 respectively refer to an end where the winding the first electrode plate 100 concludes and an end where the winding of the second electrode plate 200 concludes during the winding process of the jelly roll.

In the embodiments, a surface formed by extending a most protruding point of a bending region of the jelly roll along the thickness direction of the jelly roll is known as the first end face (i.e., the vertical dashed line in FIG. 1), the first bending region 400 is an arc-shaped face that is tangent to the first end face and is located in the bending region of the jelly roll, the first foil uncoating region 130 and the second foil uncoating region 230 are set to close to the first end face, and the first foil uncoating region 130 and the second foil uncoating region 230 are located in the first bending region 400.

On the basis of the above embodiments, with reference to FIG. 1 and FIG. 2, a size, along a winding direction, of the first foil uncoating region 130 ranges from 0.1 mm to πT/2+8 mm, where T is a thickness of the jelly roll, i.e., L1 shown in FIG. 2 is greater than or equal to 0.1 mm and is less than or equal to Tπ/2+8 mm, thereby ensuring that a projection, in the thickness direction of the jelly roll, of the first foil uncoating region 130 is located within the first bending region 400, but does not exceed the first bending region 400, and thus ensuring that on the premise of improving safety performance of a battery, an energy density of a battery cell is further improved.

On the basis of the above embodiments, with reference to FIG. 1 and FIG. 3, a size, along the winding direction, of the second foil uncoating region 230 ranges from 0.1 mm to 10 mm, i.e., L2 shown in FIG. 3 is greater than or equal to 0.1 mm and is less than or equal to 10 mm, thereby ensuring that a projection, in the thickness direction of the jelly roll, of the second foil uncoating region 230 is located within the first bending region 400, but does not exceed the first bending region 400, and thus ensuring that on the premise of improving safety performance of a battery, an energy density of a battery cell is further improved.

With reference to FIG. 1 and FIG. 2, the first electrode plate 100 further includes a priming coat 140, and the priming coat 140 is located between the first current collector 110 and the first active material layer 120. As long as a surface of the first current collector 110 is coated with the first active material layer 120, the priming coat 140 is disposed between the first current collector 110 and the first active material layer 120. Therefore, the priming coat 140 is disposed between the first current collector 110 and the first active material layer 120, which is beneficial for improving performance of a nail penetration test, thereby improving safety of a jelly roll.

In the embodiments, a material of the priming coat 140 is not further limited, and a person skilled in the art may select the material of the priming coat 140 according to actual situations, for example, the priming coat 140 may be composed of an inorganic material, a binder, and a conductive agent. A mass percentage of the inorganic material ranges from 60% to 99%, a mass percentage of the binder ranges from 0.5% to 20%, and a mass percentage of the conductive agent ranges from 0.5% to 20%. The inorganic material may be selected from one or a combination of alumina, boehmite, iron phosphate, manganese phosphate, manganese iron phosphate, aluminum phosphate, lithium nickel cobalt manganate, lithium nickel cobalt aluminate, lithium iron phosphate, sodium iron phosphate, lithium manganese phosphate, lithium manganese iron phosphate, lithium vanadium phosphate, lithium vanadium oxide phosphate, lithium vanadyl phosphate, lithium titanate, lithium manganate, and lithium nickel oxide. The binder may be selected from one or a combination of polyvinylidene fluoride, polyvinylidene fluoride-hexafluoropropylene, polypropylene, polyethylene, polytetrafluoroethylene, polystyrene, modified polyvinylidene fluoride, styrene-butadiene rubber, carboxymethyl cellulose, polyacrylic acid, polyacrylonitrile, polymethyl methacrylate, and polyacrylate. The conductive agent may be selected from one or a combination of conductive carbon black, carbon nanotubes, graphene, acetylene black, and the like.

In the embodiments, a thickness of the priming coat 140 may range from 1 μm to 30 μm, and a person skilled in the art may set the specific thickness of the priming coat 140 according to actual situations.

With reference to FIG. 1 and FIG. 2, the first electrode plate 100, disposed at an outermost ring of the jelly roll, is further provided with an insulating protective layer 150. The insulating protective layer 150 is disposed on a side surface, away from the first active material layer 120, of the first current collector 110, and the insulating protective layer 150 extends to a tail end of the first foil uncoating region 130, i.e., the insulating protective layer 150 is disposed on the side surface, facing towards an outside of the jelly roll, of the electrode plate 100 disposed at the outermost ring of the jelly roll, the first active material layer 120, opposite to the second active material layer 220, is disposed on a side surface, facing towards an inside of the jelly roll, of the electrode plate 100 disposed at the outermost ring of the jelly roll, and the insulating protective layer 150 is also disposed on a side surface, facing towards the outside of the jelly roll, of the first foil uncoating region 130. Therefore, the insulating protective layer 150 is disposed on the first electrode plate 100, so that during a nail penetration test, the insulating protective layer 150 can have an effect on preventing contact between the first current collector 110 and the second active material layer 220, thereby facilitating greatly improving safety performance of a jelly roll.

In the embodiments, a material of the insulating protective layer 150 is not further limited, and a person skilled in the art may select the material of the insulating protective layer 150 according to actual situations, for example, the insulating protective layer 150 may be composed of an inorganic material and a binder. A mass percentage of the inorganic material ranges from 50% to 99.5%, and a mass percentage of the binder ranges from 0.5% to 50%. The inorganic material may be selected from one or a combination of alumina, boehmite, magnesium oxide, magnesium hydroxide, titanium oxide, titanium dioxide, tin oxide, calcium oxide, calcium hydroxide, nickel oxide, zinc oxide, zirconium dioxide, hafnium dioxide, silicon dioxide, cerium dioxide, barium sulfate, and the like, D90 of the inorganic material is less than 40 μm, and a powder resistivity of the inorganic material is greater than 104 Ω*cm. The binder may be selected from one or a combination of polyvinylidene fluoride, polyvinylidene fluoride-hexafluoropropylene, polypropylene, polyethylene, polytetrafluoroethylene, polystyrene, modified polyvinylidene fluoride, styrene-butadiene rubber, carboxymethyl cellulose, polyacrylic acid, polyacrylonitrile, polymethyl methacrylate, and polyacrylate.

In the embodiments, a thickness of the insulating protective layer 150 may range from 1 μm to 50 μm, and a person skilled in the art may set the specific thickness of the insulating protective layer 150 according to actual situations.

In an embodiment, the first electrode plate 100 is sequentially provided with a third foil uncoating region, a first electrode plate double-sided coating region, a first electrode plate single-sided coating region (not shown in the Figures) and the first foil uncoating region 130 along the winding direction (i.e., a direction from a start end to a tail end). The third foil uncoating region refers to a region where neither of two opposite surfaces of the first current collector 110 is covered by any material, i.e., the third foil uncoating region refers to the region where neither of the two opposite surfaces of the first current collector 110 is covered by the first active material layer 120; and the first electrode plate double-sided coating region refers to a region where two opposite surfaces of the first current collector 110 are both covered by the priming coat 140 and the first active material layer 120; the first electrode plate single-sided coating region refers to a region where one of two opposite surfaces of the first current collector 110 is covered by the priming coat 140 and the first active material layer 120, and another of the two opposite surfaces of the first current collector 110 is only covered by the insulating protective layer 150; and the first foil uncoating region 130 refers to a region where one of two opposite surfaces of the first current collector 110 is not covered by any material, and another of the two opposite surfaces of the first current collector 110 is only covered by the insulating protective layer 150.

With reference to FIG. 1 and FIG. 3, the second electrode plate 200 is sequentially provided with a fourth foil uncoating region, a second electrode plate single-sided coating region, a second electrode plate double-sided coating region (not shown in the Figures) and the second foil uncoating region 230 along the winding direction. The fourth foil uncoating region refers to a region where neither of two opposite surfaces of the second current collector 210 is covered by the second active material layer 220; the second electrode plate single-sided coating region refers to a region where one of two opposite surfaces of the second current collector 210 is covered by the second active material layer 220, and another of the two opposite surfaces of the second current collector 210 is not covered by the second active material layer 220; the second electrode plate double-sided coating region refers to a region where two opposite surfaces of the second current collector 210 are both covered by the second active material layer 220; and the second foil uncoating region 230 refers to a region where neither of two opposite surfaces of the second current collector 210 is covered by the second active material layer 220.

In the thickness direction of the jelly roll, a projection of the second electrode plate double-sided coating region covers a projection of a junction between the first electrode plate single-sided coating region and the first foil uncoating region 130, i.e., a distance from the junction between the second electrode plate double-sided coating region and the second foil uncoating region 230 to the first end face is less than or equal to a distance from the junction between the first electrode plate single-sided coating region and the first foil uncoating region 130 to the first end face, and therefore, the first foil uncoating region 130 is set to extend beyond the second foil uncoating region 230 along the winding direction, which is beneficial for further improving safety performance of a jelly roll.

A person skilled in the art may set the distance from the junction of the second electrode plate double-sided coating region and the second foil uncoating region 230 to the first end face, and the distance from the junction of the first electrode plate single-sided coating region and the first foil uncoating region 130 to the first end face according to actual situations. However, in order to ensure an overall flatness of a jelly roll, the distance from the junction of the second electrode plate double-sided coating region and the second foil uncoating region 230 to the first end face is greater than or equal to T/2 mm and is less than or equal to T/2+8 mm, so that an overall flatness of a jelly roll can be ensured, thereby facilitating improving performance of a jelly roll.

The jelly roll further includes a first tab 500 and a second tab 600, the first tab 500 is connected to the first electrode plate 100, and the second tab 600 is connected to the second electrode plate 200. In the thickness direction of the jelly roll, projections of the first tab 500 and the second tab 600 do not overlap. The first tab 500 may be disposed in the third foil uncoating region, and the second tab 600 may be disposed in the fourth foil uncoating region.

The jelly roll further includes an insulating layer 700, and disposal of the insulating layer 700 may further protect a jelly roll, thereby avoiding occurrence of short circuit phenomenon. The insulating layer 700 includes a first insulating layer 710, a second insulating layer 720, a third insulating layer 730 and a fourth insulating layer 740. The first insulating layer 710 covers a side surface, facing towards an outside of the jelly roll, of the first foil uncoating region 130 and a side surface, away from the first current collector 110, of the insulating protective layer 150. The first insulating layer 710 extends towards the first bending region 400, and in the thickness direction of the jelly roll, a projection of the first insulating layer 710 covers a projection of the first bending region 400. The second insulating layer 720 covers a junction between the first electrode plate single-sided coating region and the first foil uncoating region 130. The third insulating layer 730 covers a junction between the first electrode plate double-sided coating region and the first electrode plate single-sided coating region. The fourth insulating layer 740 covers a junction between the third foil uncoating region and the first electrode plate double-sided coating region. Therefore, safety risks, such as short circuits or leakage, caused by burrs of an active material piercing through the separator 300 or a housing at the junctions between the first electrode plate single-sided coating region and the first foil uncoating region 130, and between the first electrode plate double-sided coating region and the first electrode plate single-sided coating region, can be avoided.

The insulating layer 700 further includes a fifth insulating layer 750, a sixth insulating layer 760, and a seventh insulating layer 770. The fifth insulating layer 750 covers a surface of the first tab 500, the sixth insulating layer 760 covers a surface of the second tab 600, and the seventh insulating layer 770 covers a position, opposite to a start end of the third foil uncoating region, of the second electrode plate 200, and therefore, occurrence of short circuits, caused by burrs piercing through the separator 300 at edges of the first tab 500, the second tab 600 and the third foil uncoating region, can be avoided.

In the embodiments, a material of the insulating layer 700 is not further limited, and a person skilled in the art may select the material of the insulating layer 700 according to actual situations, for example, the material of the insulating layer 700 may be selected from one or a combination of acrylic adhesives, rubber adhesives, hot melt adhesives, and the like.

In the embodiments, lengths of the above insulating layers are not further limited, and a person skilled in the art may set the lengths of the above insulating layers according to actual situations, as long as short circuit phenomenon, caused by burrs piercing through the separator 300 at lithium dendrites formed by lithium precipitation or cutting ports, can be avoided.

On the basis of the above embodiments, the first electrode plate 100 is a positive electrode plate, and the second electrode plate 200 is a negative electrode plate, which not only improves an energy density of a battery and a pass rate of a nail penetration test, but also can prevent corrosion caused by formation of a galvanic cell between a jelly roll and an outer housing after the jelly roll is wound.

In the above embodiments, a material of the first electrode plate 100 and a material of the second electrode plate 200 may be one or more types of metal foils, such as an aluminum foil, a copper foil, a nickel foil, a gold foil and a platinum foil. Preferably, the material of the first electrode plate 100 is the aluminum foil, the material of the second electrode plate 200 is the copper foil, the material of the first tab 500 is also the aluminum foil, and the material of the second tab 600 is the copper foil.

In the embodiments, a tail end of the separator 300 exceeds beyond a tail end of the second foil uncoating region 230. After the separator 300 is wound, the wound separator 300 has two tail ends, and the two tail ends wrap the tail end of the second foil uncoating region 230, thereby further improving safety of a jelly roll.

In the embodiments, a dimension by which the tail end of the separator 300 extends beyond the tail end of the second foil uncoating region 230 is not further limited, and a person skilled in the art may set the dimension according to actual situations, for example, the dimension by which the tail end of the separator 300 exceeds beyond the tail end of the second foil uncoating region 230 is greater than or equal to 1 mm.

An energy density of a conventionally structured jelly roll (i.e., a tail end of a first foil uncoating region 130 extends beyond a first bending region 400 and is located in a flat region) is Q, and in the jelly roll of the embodiments, a thickness of the jelly roll is T, a thickness of the first current collector 110 is T1, and a thickness of the insulating protective layer 150 is T2, and therefore, an energy density of the jelly roll of the embodiments is Q1=T*Q/(T−T1−T2).

A second aspect of the embodiments of the present disclosure provides a battery, the battery includes a housing and the jelly roll according to the first aspect, and the jelly roll is packaged in the housing.

In the embodiments, the housing is not further limited, and a person skilled in the art may select the housing according to actual situations, for example, the housing is an aluminum laminated film housing.

In the battery provided in the embodiments, the first foil uncoating region 130 disposed at the tail end of the first electrode plate 100 and the second foil uncoating region 230 disposed at the tail end of the second electrode plate 200 are designed to be located in the first bending region 400, and the projections, in the thickness direction of the jelly roll, of the first foil uncoating region 130 and the second foil uncoating region 230 are designed to not exceed the first bending region 400, so that the first foil uncoating region 130 and the second foil uncoating region 230 are both located in the first bending region 400, but both the first foil uncoating region 130 and the second foil uncoating region 230 are wound around part of the first bending region 400, which makes pass rates of nail penetration more consistent at different positions of a jelly roll, thereby avoiding problems of inconsistent pass rates of nail penetration at different positions, and thus facilitating improving safety performance of a battery. In addition, both the first foil uncoating region 130 and the second foil uncoating region 230 that are located at the tail end of the jelly roll are wound around part of the first bending region 400, which reduces a size of foil uncoating regions that do not contribute to capacity, thereby facilitating improving an energy density of a battery. Additionally, having both the two foil uncoating regions 130, 230 at the tail end of the jelly roll in the first bending region 400, as opposed to two foil uncoating regions being on a flat plane, reduces a risk of burrs, formed by cutting a tail end of a jelly roll, piercing through the separator 300 of the jelly roll, which can effectively reduce short circuit points of a jelly roll, thereby improving consistency of self-discharge of a jelly roll.

In order to further illustrate the jelly roll of the embodiments in improving safety and increasing an energy density, the following comparative examples are used for further explanation.

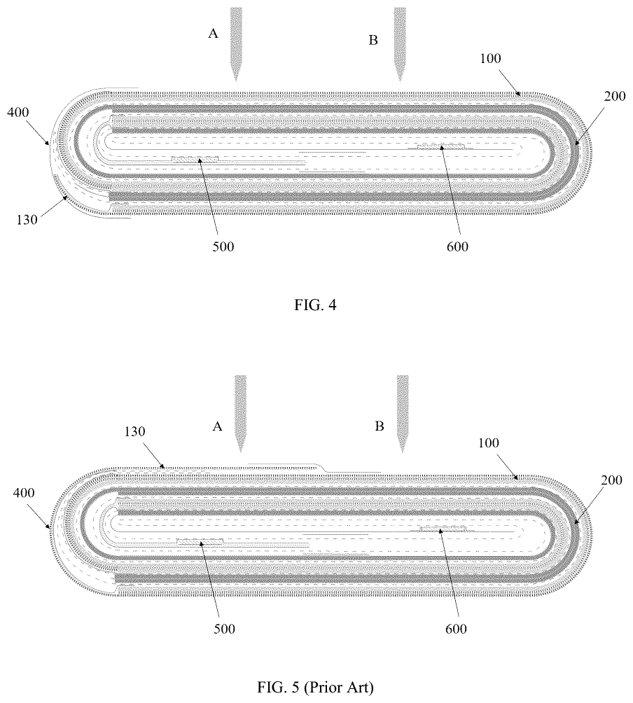

The embodiments of the present disclosure use the structure of the jelly roll in FIG. 4.

Comparative example 1 uses a conventionally structured jelly roll, i.e., the structure of the jelly roll in FIG. 5 is used, and a tail end of a first foil uncoating region 130 extends beyond a first bending region 400 and is located in a flat region.

Comparative example 2 uses the structure of the jelly roll in FIG. 4, but a first current collector 110 is not provided with a priming coat 140 and an insulating protective layer 150.

Comparative example 3 uses the structure of the jelly roll in FIG. 4, but a first current collector 110 is not provided with a priming coat 140 and an insulating protective layer 150, and a tail end of a first foil uncoating region 130 extends beyond a first bending region 400 and is located in a flat region.

The jelly roll of the embodiments of the present disclosure and the jelly rolls of the comparative example 1 to the comparative example 3 were subjected to a nail penetration test, conditions of the nail penetration test are that a 3 mm steel nail is used to pierce through the battery at positions A and B (the two positions may be referred to FIG. 4 and FIG. 5) at a speed of 30 mm/s. The criteria for judgment are: if the battery neither smokes nor catches fire, it is determined that the battery passes the test, and if the battery smokes or catches fire, it is determined that the battery does not pass the test. A test result is shown in Table 1.

TABLE 1

| | Energy | Pass rate of nail | Pass rate of nail |
|---|---|---|---|
| | density | penetration test | penetration test |
| Group | (Wh/L) | at position A (%) | at position B (%) |
| Embodiments of the | 720 | 100 | 100 |
| present disclosure | | | |
| Comparative | 712 | 68 | 100 |
| example 1 | | | |
| Comparative | 748 | / | / |
| example 2 | | | |
| Comparative | 743 | / | / |
| example 3 | | | |

The conventionally structured jelly roll of the comparative example 1 was tested at the position A for 50 pcs, the battery smokes and catches fire at 16 pcs, and the pass rate is 68%; and the conventionally structured jelly roll of the comparative example 1 was tested at the position B for 50 pcs, the battery smokes and catches fire at 0 pcs, and the pass rate is 100%. It can be seen that the pass rates of the nail penetration test of the conventionally structured jelly roll at the positions A and B are obviously different, a charging and discharging voltage of the conventionally structured jelly roll ranges from 4.45 V to 3 V, a capacity of the conventionally structured jelly roll is 5000 mAh, and an energy density of the conventionally structured jelly roll is 712 Wh/L. However, the jelly roll of the embodiments of the present disclosure was tested at the position A for 50 pcs, the battery smokes and catches fire at 0 pcs, and the pass rate is 100%; and the jelly roll of the embodiments of the present disclosure was tested at the position B for 50 pcs, the battery smokes and catches fire at 0 pcs, and the pass rate is 100%. It can be seen that the pass rates of the nail penetration test of the jelly roll of the embodiments of the present disclosure at the positions A and B are obviously improved, a charging and discharging voltage of the jelly roll of the embodiments of the present disclosure ranges from 4.45 V to 3V, a capacity of the jelly roll of the embodiments of the present disclosure is 5000 mAh, and an energy density of the jelly roll of the embodiments of the present disclosure is 720 WH/L. Compared with the conventionally structured jelly roll (for example, a lithium-ion battery), the energy density of the jelly roll of the embodiments of the present disclosure is increased by 8 WH/L.

In addition, it can be seen from Table 1 that the priming coat 140 and the insulating protective layer 150 are disposed on the first current collector 110, so that performance of the nail penetration test can be ensured, thereby facilitating improving safety of a jelly roll.

Although the present disclosure is disclosed as above, the protection scope of the present disclosure is not limited thereto. A person skilled in the art may make various changes and modifications without departing from the spirit and the scope of the present disclosure, and these changes and modifications all fall within the protection scope of the present disclosure.

What is claimed is:

1. A jelly roll, comprising a first electrode plate and a second electrode plate that are disposed in a stacked manner, wherein
the first electrode plate is wound from a start end of the first electrode plate to a tail end of the first electrode plate, and the second electrode plate is wound from a start end of the second electrode plate to a tail end of the second electrode plate;
the tail end of the first electrode plate is a first foil uncoating region, and the tail end of the second electrode plate is a second foil uncoating region; and
the jelly roll comprises a first bending region disposed at an outermost side of the jelly roll, the tail end of the first electrode plate and the tail end of the second electrode plate are both located in the first bending region, and neither of projections, in a thickness direction of the jelly roll, of the first foil uncoating region and the second foil uncoating region exceeds the first bending region.

2. The jelly roll according to claim 1, wherein a size, along a winding direction, of the first foil uncoating region ranges from 0.1 mm to πT/2+8 mm, where T is a thickness of the jelly roll.

3. The jelly roll according to claim 1, wherein a size, along a winding direction, of the second foil uncoating region ranges from 0.1 mm to 10 mm.

4. The jelly roll according to claim 1, wherein the first electrode plate comprises a first current collector and a first active material layer, and at a position where the first foil uncoating region is located, neither of two side surfaces of the first current collector is coated with the first active material layer.

5. The jelly roll according to claim 4, wherein the first electrode plate further comprises a priming coat located between the first current collector and the first active material layer.

6. The jelly roll according to claim 4, wherein the first electrode plate, disposed at an outermost ring of the jelly roll, is further provided with an insulating protective layer, the insulating protective layer is disposed on a side surface, away from the first active material layer, of the first current collector, and the insulating protective layer extends to a tail end of the first foil uncoating region.

7. The jelly roll according to claim 1, wherein the first electrode plate is sequentially provided with a third foil uncoating region, a first electrode plate double-sided coating region, a first electrode plate single-sided coating region and the first foil uncoating region along a winding direction.

8. The jelly roll according to claim 7, wherein the second electrode plate is sequentially provided with a fourth foil uncoating region, a second electrode plate single-sided coating region, a second electrode plate double-sided coating region and the second foil uncoating region along the winding direction.

9. The jelly roll according to claim 8, wherein in the thickness direction of the jelly roll, a projection of the second electrode plate double-sided coating region covers a projection of a junction between the first electrode plate single-sided coating region and the first foil uncoating region.

10. The jelly roll according to claim 8, wherein a distance from a junction between the second electrode plate double-sided coating region and the second foil uncoating region to a first end face is greater than or equal to T/2 mm and is less than or equal to T/2+8 mm, the first end face is a face formed by extending a most protruding point of a bending region of the jelly roll along the thickness direction of the jelly roll, and T is a thickness of the jelly roll.

11. The jelly roll according to claim 8, wherein the first foil uncoating region extends beyond the second foil uncoating region along the winding direction.

12. The jelly roll according to claim 8, further comprising a first tab and a second tab, wherein the first tab is disposed in the third foil uncoating region, the second tab is disposed in the fourth foil uncoating region, and projections of the first tab and the second tab do not overlap in the thickness direction of the jelly roll.

13. The jelly roll according to claim 12, further comprising an insulating layer, wherein the insulating layer comprises a first insulating layer, a second insulating layer, a third insulating layer, a fourth insulating layer, a fifth insulating layer, a sixth insulating layer, and a seventh insulating layer, the fifth insulating layer covers a surface of the first tab, the sixth insulating layer covers a surface of the second tab, the seventh insulating layer covers a position, opposite to a start end of the third foil uncoating region, of the second electrode plate, the fourth insulating layer covers a junction between the third foil uncoating region and the first electrode plate double-sided coating region, the third insulating layer covers a junction between the first electrode plate double-sided coating region and the first electrode plate single-sided coating region, the second insulating layer covers a junction between the first electrode plate single-sided coating region and the first foil uncoating region, the first insulating layer covers at least one of a side surface, facing towards an outside of the jelly roll, of the first foil uncoating region and a side surface, away from a first current collector of the first electrode plate, of an insulating protective layer, and the insulating protective layer is disposed on the first electrode plate disposed at an outermost ring of the jelly roll.

14. The jelly roll according to claim 13, wherein the first insulating layer extends towards the first bending region, and in the thickness direction of the jelly roll, a projection of the first insulating layer covers a projection of the first bending region.

15. The jelly roll according to claim 1, wherein polarities of the first electrode plate and the second electrode plate are opposite, the first electrode plate is a positive electrode plate, and the second electrode plate is a negative electrode plate.

16. The jelly roll according to claim 1, wherein the second electrode plate comprises a second current collector and a second active material layer, and at a position where the second foil uncoating region is located, neither of two side surfaces of the second current collector is coated with the second active material layer.

17. The jelly roll according to claim 1, further comprising a separator disposed between the first electrode plate and the second electrode plate, wherein the separator is wound from a start end of the separator to a tail end of the separator.

18. The jelly roll according to claim 17, wherein the tail end of the separator exceeds beyond a tail end of the second foil uncoating region.

19. The jelly roll according to claim 17, wherein the separator is provided with two tail ends, and the two tail ends wrap a tail end of the second foil uncoating region.

20. A battery, comprising a housing and a jelly roll, wherein the jelly roll is packaged in the housing, and the jelly roll comprises a first electrode plate and a second electrode plate that are disposed in a stacked manner;
the first electrode plate is wound from a start end of the first electrode plate to a tail end of the first electrode plate, and the second electrode plate is wound from a start end of the second electrode plate to a tail end of the second electrode plate;
the tail end of the first electrode plate is a first foil uncoating region, and the tail end of the second electrode plate is a second foil uncoating region; and
the jelly roll comprises a first bending region disposed at an outermost side of the jelly roll, the tail end of the first electrode plate and the tail end of the second electrode plate are both located in the first bending region, and neither of projections, in a thickness direction of the jelly roll, of the first foil uncoating region and the second foil uncoating region exceeds the first bending region.
